(19) United States
(12) Patent Application Publication
(10) Pub. No.: US 2020/0221038 A1
(43) Pub. Date: Jul. 9, 2020

(54) IMAGE PROCESSING DEVICE, IMAGE PROCESSING METHOD, AND COMPUTER READABLE STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: TE-EN TSENG, New Taipei (TW); TSAI-YI CHIEN, New Taipei (TW)

(21) Appl. No.: 16/397,486

(22) Filed: Apr. 29, 2019

(30) Foreign Application Priority Data
Jan. 7, 2019 (CN) 201910012769.8

(51) Int. Cl. H04N 5/247; H04N 5/232; G06T 7/593; H04N 5/262; H04N 13/254; H04N 13/239; H04N 9/04

(52) U.S. Cl. CPC H04N 5/247; H04N 5/23245; G06T 7/593; H04N 5/2628; G06T 2207/10024; H04N 13/239; H04N 9/045; G06T 2207/10048; G06T 2207/10012; H04N 13/254

(57) ABSTRACT

An image processing device includes an input unit, a display unit, a communication unit, a storage unit, a processor, at least one first camera, and at least one second camera. The first camera includes an infrared light filter and a switch configured for controlling the first camera to switch between a first mode and a second mode. The storage unit stores one or more programs, when executed by the processor, the one or more programs causing the processor to: control the switch to switch the first camera to the first mode; control the first camera to capture a first image in the first mode; control the second camera to capture a second image; obtain a depth image by performing frame synchronization processing on the first image and the second image; and output the depth image. An image processing method and a computer readable storage medium are also provided.

### FIELD

The disclosure generally relates to image processing technology.

### BACKGROUNDING

At present, binocular stereo cameras are used in 3D sensing devices. In order to adapt to both bright and dark environments, the binocular stereo camera has been transformed from a single camera to a dual camera, and needs to be used with a fill light member. The binocular stereo cameras described above may be large in size and high in cost.

Therefore, there is room for improvement within the art.

### BRIEF DESCRIPTION OF THE DRAWING

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a schematic diagram of an image processing device in accordance with an embodiment of the present disclosure.

FIG. 2 is a schematic diagram of a control system in accordance with an embodiment of the present disclosure.

FIG. 3 is a flow diagram of an image processing method in accordance with an embodiment of the present disclosure.

FIG. 4 is a flow diagram of the image processing method in accordance with another embodiment of the present disclosure.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series, and the like. The term “coupled” is defined as connected, whether directly or indirectly through intervening components, and is not necessarily limited to direct physical connection. The connection can be such that the objects are permanently connected or releasably connected.

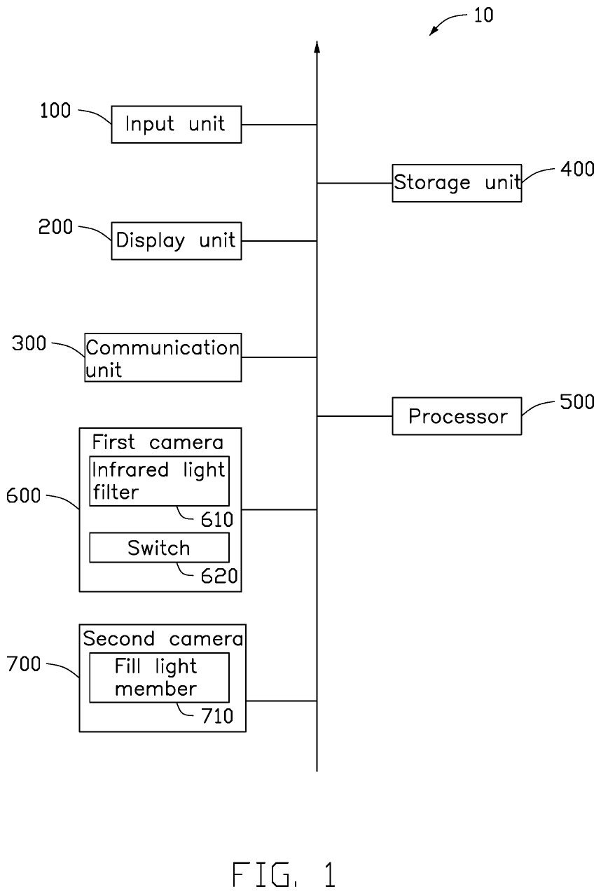

FIG. 1 shows an image processing device 10 in accordance with an embodiment of the present disclosure. The image processing device 10 includes an input unit 100, a display unit 200, a communication unit 300, a storage unit 400, a processor 500, at least one first camera 600, and at least one second camera 700.

In the present embodiment, the image processing device 10 includes one first camera 600 and one second camera 700. In other embodiments, there can be multiple of the first cameras 600 and/or multiple of the second cameras 700.

The input unit 100, the display unit 200, the storage unit 400, the first camera 600, and the second camera 700 are electrically connected to the processor 500. Image capturing planes of the first camera 600 and the second camera 700 are located on the same plane, so that resolution of images obtained by the first camera 600 and the second camera 700 are the same.

The input unit 100 allows a user to input control commands. The input unit 100 may be, but is not limited to, a touch screen, a remote controller, a voice input device, and the like.

The display unit 200 displays a processing result of the processor 500. The display unit 200 includes at least one display.

The communication unit 300 allows the image processing device 10 to communicatively couple to other mobile terminals. In the present embodiment, the communication unit 300 communicates with other mobile terminals through a wireless network, the wireless network may be, but is not limited to, WIFI, BLUETOOTH, cellular mobile network, satellite network, and NFC. In addition, the communication unit 300 includes independent WIFI ports that allow connections by other mobile terminals.

In other embodiments, the communication unit 300 communicates with other mobile terminals through a wired network. The wired network may be, but is not limited to, USB, IEEE1394, and the like.

The storage unit 400 stores data of the image processing device 10, such as image data, program code, and the like. The storage unit 400 realizes high-speed, automatic completion of program or data access during the operation of the image processing device 10. The storage unit 400 also stores an image depth algorithm. A depth image can be obtained by processing an image according to the image depth algorithm.

The storage unit 400 may be, but is not limited to, a read-only memory, a random-access memory, a programmable read-only memory, an erasable programmable read-only memory, a one-time programmable read-only memory, an electrically-erasable programmable read-only memory, or a compact disc read-only memory. The storage unit 400 may also be an optical disk storage, a magnetic disk storage, a magnetic tape storage, or any other medium readable by a computer that can be used to store data.

The processor 500 may be, but is not limited to, a digital signal processor, a microcontroller unit, an advanced RISC machine, a field-programmable gate array, a central processing unit, a single chip, or a system on chip.

The first camera 600 is a color camera. The image captured by the first camera 600 is equivalent to human eye vision, and images captured by the first camera 600 are minimally processed. The first camera 600 includes an imaging sensor and an infrared light filter 610. The infrared light filter 610 enables the first camera 600 to filter infrared light. Specifically, the infrared light filter 610 includes IRs cut filter and/or blue glass. Without using the infrared light filter 610, the imaging sensor responds to infrared light that is invisible to human eye, so the captured image can be tinged with red and different from the image seen by the human eye.

The second camera 700 is a stereo camera. The image obtained by the second camera 700 is referred to as machine vision, and images captured by the second cameral 700 are extensively processed. The second camera 700 includes an imaging sensor and a fill light member 710. The fill light member 710 enables the second camera 700 to be used in a dark environment.

The first camera 600 has a switch 620 to control the first camera 600 to switch between a first mode and a second mode. In the first mode, the infrared filter 610 is turned off by the switch 620 such that the first camera 600 does not have the function of filtering infrared light. In the second mode, the infrared filter 610 is turned on by the switch 620 such that the first camera 600 has the function of filtering infrared light.

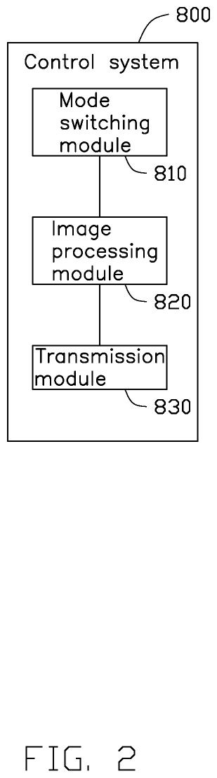

FIG. 2 shows a control system 800 operated by the image processing device 10 in accordance with an embodiment of the present disclosure. The control system 800 includes computer instructions in the form of one or more programs stored in the storage unit 400 and executed by the processor 500.

As shown in FIG. 2, the control system 800 includes a mode switching module 810, an image processing module 820, and a transmission module 830.

The mode switching module 810 controls the first camera 600 to switch between the first mode and the second mode. The mode switching module 810 stores a user-controlled image-capturing program, and the user captures images in different modes according to the user-controlled image-capturing program.

The image processing module 820 receives captured image data and performs corresponding image processing on the captured image data according to different modes.

The transmission module 830 transmits the images captured by the first camera 600 and the second camera 700 to the image processing module 820, and outputs an image after processing.

The image processing device 10 may be, but is not limited to, a video camera, a mobile phone, a tablet computer, a notebook computer, a police service, or a smart TV.

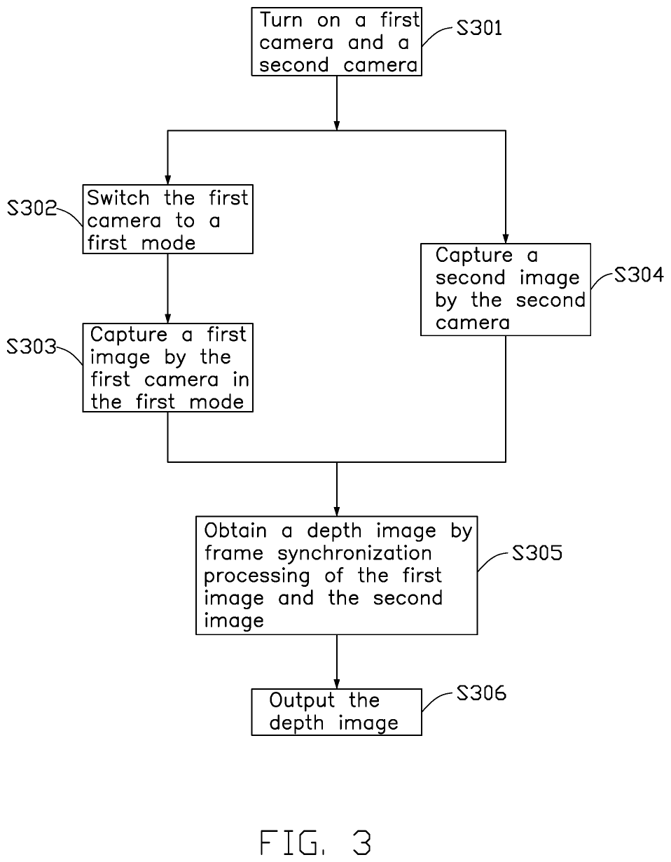

FIG. 3 shows a flow diagram of an image processing method in accordance with an embodiment of the present disclosure. The method is provided by way of embodiments, as there are a variety of ways to carry out the method. Each block shown in FIG. 3 represents one or more processes, methods, or subroutines carried out in the example method. The method can begin at block S301.

At block 301, the first camera 600 and the second camera 700 are simultaneously turned on.

Specifically, the input unit 100 inputs an instruction to turn on the first camera 600 and the second camera 700. The control system 800 simultaneously turns on the first camera 600 and the second camera 700 to prepare to take an image.

At block S302, the first camera 600 is switched to the first mode by the switch 620.

Specifically, the control system 800 turns off the infrared light filter 610 of the first camera 600 according to the user-controlled image-capturing program, so that the first camera 600 is in the first mode.

At block S303, a first image is captured by the first camera 600 in the first mode.

Specifically, the control system 800 controls the first camera 600 to capture the first image in the first mode, and the first image is stored in the storage unit 400.

At block S304, a second image is captured by the second camera 700.

Specifically, the control system 800 controls the second camera 700 to capture the second image, and the second image is stored in the storage unit 400.

At block S305, a depth image is obtained by frame synchronization processing of the first image and the second image.

Specifically, the first image and the second image are transmitted to the image processing module 820 through the transmission module 830. The process of the obtaining the depth image includes: preprocessing the first image, such as by cropping and scaling; performing frame synchronization processing on the second image and the first image after preprocessing; and obtaining the depth image according to the image depth algorithm.

At block S306, the depth image is output.

The depth image is output through the communication unit 300 to other mobile terminals communicated with the image processing device 10.

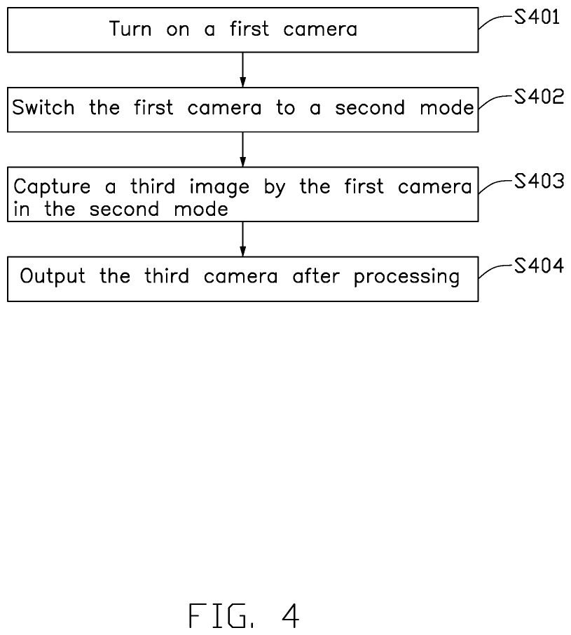

FIG. 4 shows a flow diagram of an image processing method in accordance with another embodiment of the present disclosure. In the present embodiment, the method can begin at block S401.

At block 401, the first camera 600 is turned on while the second camera 700 is turned off

The control system 800 controls the first camera 600 to be turned on and the second camera 700 to be turned off

At block 402, the first camera 600 is switched to the second mode by the switch 620.

Specifically, the control system 800 turns on the infrared light filter 610 of the first camera 600 according to the user-controlled image-capturing program, so that the first camera 600 is in the second mode.

At block 403, a third image is captured by the first camera 600 in the second mode.

Specifically, the control system 800 controls the first camera 600 to capture the third image in the second mode, and the third image is stored in the storage unit 400.

At block 404, the third image is output after processing.

Specifically, the third image is transmitted to the image processing module 820 through the transmission module 830. The third image is processed by the image processing module 820 to display the image seen by the human eye. The third image after processing is output through the communication unit 300 to other mobile terminals communicated with the image processing device 10.

It can be understood that when the first camera 600 is in the second mode, the first camera 600 is suitable for capturing images in a bright environment. When the first camera 600 is in the first mode, the first camera 600 is suitable for capturing images in a dark environment\. Because the infrared filter is turned off when the first camera 600 is in the first mode, the imaging sensor can respond to infrared light.

The image processing device 10 provided by the present disclosure can realize multiple modes of shooting, has a small size, and low cost.

In addition, each functional unit in each embodiment of the present disclosure may be integrated into one processor, or each unit may an individual item, or two or more units may be integrated in one unit. The above integrated unit can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An image processing device, comprising an input unit, a display unit, a communication unit, a storage unit, a processor, at least one first camera, and at least one second camera,
wherein the first camera comprises an infrared light filter and a switch configured for controlling the first camera to switch between a first mode and a second mode, when the first camera is in the first mode, the infrared light filter is turned off by the switch; when the first camera is in the second mode, the infrared light filter is turned on by the switch,
wherein the storage unit stores one or more programs, when executed by the processor, the one or more programs causing the processor to:
control the switch to switch the first camera to the first mode;
control the first camera to capture a first image in the first mode;
control the second camera to capture a second image;
obtain a depth image by performing frame synchronization processing on the first image and the second image; and
output the depth image.

2. The image processing device as claimed in claim 1, wherein the input unit, the display unit, the storage unit, the first camera, and the second camera are electrically connected to the processor.

3. The image processing device as claimed in claim 1, wherein image capturing planes of the first camera and the second camera are defined on a same plane.

4. The image processing device as claimed in claim 1, wherein the processor is further configured to output the depth image to mobile terminals communicating with a communication unit of the image processing device.

5. The image processing device as claimed in claim 1, wherein the infrared light filter comprises IRs cut filter and/or blue glass.

6. The image processing device as claimed in claim 1, wherein the second camera comprises a fill light member.

7. The image processing device as claimed in claim 1, wherein the processor is further configured to:
cropping and scaling the first image;
performing frame synchronization processing on the second image and the first image after cropping and scaling the first image; and
obtaining the depth image according to an image depth algorithm stored in the storage unit.

8. The image processing device as claimed in claim 1, wherein the storage unit stores one or more programs, when executed by the processor, the one or more programs further causing the processor to:
control the switch to switch the first camera to the second mode;
control the first camera to capture a third image in the second mode; and
output the third image after processing.

9. An image processing method adapted to an image processing device, the image processing device comprising at least one first camera and at least one second camera,
wherein the first camera comprises an infrared light filter and a switch configured for controlling the first camera to switch between a first mode and a second mode, when the first camera is in the first mode, the infrared light filter is turned off by the switch; when the first camera is in the second mode, the infrared light filter is turned on by the switch,
wherein the image processing method comprises:
controlling the switch to switch the first camera to the first mode;
controlling the first camera to capture a first image in the first mode;
controlling the second camera to capture a second image;
obtaining a depth image by performing frame synchronization processing on the first image and the second image; and
outputting the depth image.

10. The image processing method as claimed in claim 9, wherein image capturing planes of the first camera and the second camera are defined on a same plane.

11. The image processing method as claimed in claim 9, wherein the infrared light filter comprises IRs cut filter and/or blue glass.

12. The image processing method as claimed in claim 9, wherein the second camera comprises a fill light member.

13. The image processing method as claimed in claim 9, wherein the process of obtaining the depth image comprises:
cropping and scaling the first image;
performing frame synchronization processing on the second image and the first image after preprocessing; and
obtaining the depth image according to an image depth algorithm.

14. The image processing method as claimed in claim 9, wherein the method further comprises:
controlling the switch to switch the first camera to the second mode;
controlling the first camera to capture a third image in the second mode; and
outputting the third image after processing.

15. A computer readable storage medium, configuring for storing computer programs codes for executing an image processing method adapted to an image processing device, the image processing device comprises at least one first camera and at least one second camera,
wherein the first camera comprises an infrared light filter and a switch configured for controlling the first camera to switch between a first mode and a second mode, when the first camera is in the first mode, the infrared light filter is turned off by the switch; when the first camera is in the second mode, the infrared light filter is turned on by the switch,
wherein the image processing method comprises:
controlling the switch to switch the first camera to the first mode;
controlling the first camera to capture a first image in the first mode;
controlling the second camera to capture a second image; and
obtaining a depth image by perform frame synchronization processing on the first image and the second image; and
outputting the depth image.

16. The computer readable storage medium as claimed in claim 15, wherein image capturing planes of the first camera and the second camera are defined at a same plane.

17. The computer readable storage medium as claimed in claim 15, wherein the infrared light filter comprises IRs cut filter and/or blue glass.

18. The computer readable storage medium as claimed in claim 15, wherein the second camera comprises a fill light member.

19. The computer readable storage medium as claimed in claim 15, wherein the process of obtaining the depth image comprises:
cropping and scaling the first image;
performing frame synchronization processing on the second image and the first image after cropping and scaling the first image; and
obtaining the depth image according to an image depth algorithm.

20. The computer readable storage medium as claimed in claim 15, wherein the image processing method further comprises:
controlling the switch to switch the first camera to the second mode;
controlling the first camera to capture a third image in the second mode; and
outputting the third image after processing.
